(19) United States
(12) Patent Application Publication
(10) Pub. No.: US 2002/0181014 A1
(43) Pub. Date: Dec. 5, 2002

(54) Methods and systems for managing printing resources

(76) Inventor: Donald K. Wadley, Boise, ID (US)

Correspondence Address: HEWLETT-PACKARD COMPANY, Intellectual Property Administration, P. O. Box 272400, Fort Collins, CO, 80527-2400, US

(21) Appl. No.: 09/874,182

(22) Filed: Jun. 4, 2001

(51) Int. Cl. B41B 1/00; G06F 15/00

(52) U.S. Cl. 358/1.15; 358/1.13

(57) ABSTRACT

The methods and systems described below provide a means by which an organization can monitor the content of documents being printed on organization printer resources. The techniques permit monitoring software to be installed on a printer. The monitoring software processes data streams that are received into the printer and which are intended for printing, and determines, based on a potential variety of factors, whether the data streams are associated with documents that are of interest to the organization. If a data stream is determined to be associated with a document of interest to the organization, the organization can be notified to that effect. The inventive techniques can be transparent to the user of printers so that a degree of stealthyness is provided. The inventive techniques are especially well-suited as tools for resource or document security and resource management.

### TECHNICAL FIELD

This invention relates to methods and systems of managing printing resources, and, in particular, to methods and systems of managing organizational printing resources.

### BACKGROUND

Printers, particularly those that can be used by companies or organizations, are often used to print a wide range of material. Such material typically includes information that may or may not be sensitive. For example, such sensitive material might include financial records, performance evaluations, resumes and the like. To date, a great deal of effort has been expended by those in the printing industry to provide security solutions for printers so that sensitive material is printed only by those individuals who are authorized to print it or on authorized print resources. Exemplary security solutions include the use of lock boxes, secure printing environments, printer access codes that restrict the use of the printer to certain individuals or that restrict the access that individuals have to various resources. Needless to say, there have been many and varied attempts to solve printer security issues.

The security issue underscores or exemplifies a more general need within organizations that touches upon the ability (or lack thereof) of an organization to efficiently, effectively and robustly manage its printer resources.

In recent years, within the printer industry, there have been attempts to increase the value that third party vendors can provide for printers. Specifically, efforts have been expended to standardize both the hardware and software interfaces that third party vendors can use. As a result, these vendors can write software programs or add hardware or firmware that interact with the printer in a more meaningful way. Thus, in some respects, some printer manufacturers, such as the assignee of this document, can provide a printer platform that can then be “extended”by other third parties such as third party software vendors.

In the recent past, attempts to standardize the printer interfaces have been made with the ultimate goal of simplicity and ease of leverage in mind. For example, defining software interfaces so that a standardized programmatic approach can be used to interact with the interface can greatly facilitate third party interaction. As an example, using Java-based interfaces can allow those with Java programming expertise to interact in a meaningful and robust way with the printer and the data that it contains. Such interaction is typically facilitated by a Java Virtual Machine (JVM) that is incorporated as part of a printer's software. JVM's are known, examples of which are described in U.S. Pat. Nos. 6,115,719, 5,943,496, 6,170,083, 6,110,226, and 6,070,173.

Having standardized interfaces can thus allow access to great variety of information within the printer. For example, using an interface, one can access and use information concerning the status of the internal components of the printer (i.e. toner, buffers, and the like). In addition, the incoming data stream can be accessed through an appropriate interface so that, for example, it can be converted into a different format for printing. Accordingly, as will be appreciated by those of skill in the art, the present state of printer technology is such that robust interaction can be had with printers through various interfaces that are provided on the printers or on their software.

Against this backdrop, there exists a continuing need to provide a high degree of interaction with printers. This is true not only from the security standpoint, but more generally, from the resource management standpoint.

This invention arose out of concerns associated with providing improved methods and systems for interacting with and managing printers. This invention also arose out of concerns associated with providing improved security systems and methods that can be used in today's robust printer environment.

### SUMMARY

The methods and systems described below provide a means by which an organization can monitor the content of documents being printed on organization printer resources. The techniques permit monitoring software to be installed on a printer. The monitoring software processes data streams that are received into the printer and which are intended for printing, and determines, based on a potential variety of factors, whether the data streans are associated with documents that are of interest to the organization. If a data stream is determined to be associated with a document of interest to the organization, the organization can be notified to that effect. The inventive techniques can be transparent to the printer user so that a degree of stealthyness is provided. The inventive techniques are especially well-suited as tools for resource or document security and resource management.

### BRIEF DESCRIPTION OF THE DRAWINGS

The same numbers are used throughout the drawings to reference like features and components.

FIG. 1 is an illustration of an exemplary network in which the inventive techniques and systems can be employed.

FIG. 2 is a block diagram that illustrates various components of an exemplary printer.

FIG. 3 is a block diagram that illustrates various components of an exemplary work station.

FIG. 4 is a block diagram that illustrates selected components of a printer in accordance with one embodiment.

FIG. 5 is a diagram that illustrates an exemplary enterprise network in which the inventive techniques and systems can be employed.

FIG. 6 is a block diagram that illustrates an exemplary context-analyzer in accordance with one embodiment.

FIG. 7 is a flow diagram that describes steps in a method in accordance with one embodiment.

FIG. 8 is a flow diagram that describes steps in a method in accordance with one embodiment.

### DETAILED DESCRIPTION

Overview

The methods and systems described below provide a means by which an organization can monitor the content of documents being printed on organization printer resources. The techniques permit monitoring software to be installed on a printer. The monitoring software processes data streams that are received into the printer and which are intended for printing, and determines, based on a potential variety of factors, whether the data streams are associated with documents that are of interest to the organization. If a data stream is determined to be associated with a document of interest to the organization, the organization can be notified to that effect.

Exemplary Network Environment

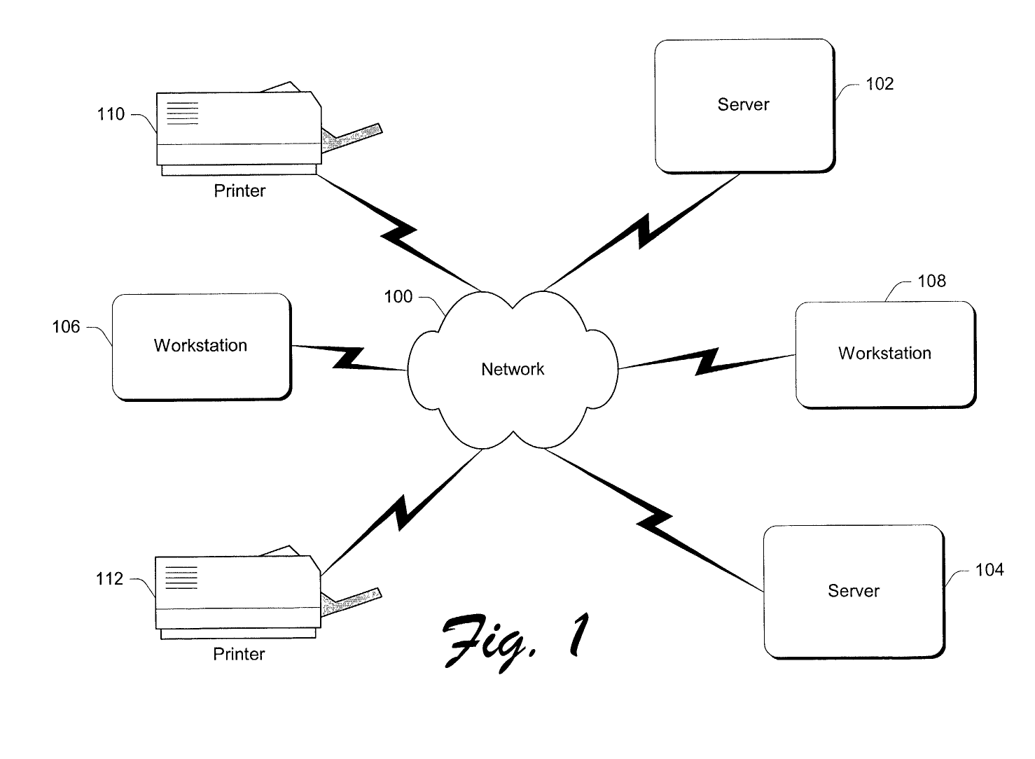

FIG. 1 illustrates a network environment in which the inventive techniques and structures described herein can be employed. The network environment can comprise multiple servers, workstations, and printers that are coupled to one another via a data communication network 100. The network 100 couples together servers 102 and 104, computer workstations 106 and 108, and printers 110 and 112. Network 100 can be any type of network, such as a local area network (LAN) or a wide area network (WAN), using any type of network topology and any network communication protocol. Although only a few devices are shown coupled to network 100, a typical network may have tens or hundreds of devices coupled to one another. Furthermore, network 100 may be coupled to one or more other networks, thereby providing coupling between a greater number of devices. Such can be the case, for example, when networks are coupled together via the Internet.

Servers 102 and 104 may be file servers, email servers, database servers, or any other type of network server. Workstations 106 and 108 can be any type of computing device, such as a personal computer. In particular embodiments, printers 110 and 112 can be laser printers. However, alternate embodiments can be implemented in connection with ink-jet or any other type of printer.

Exemplary Printer Architecture

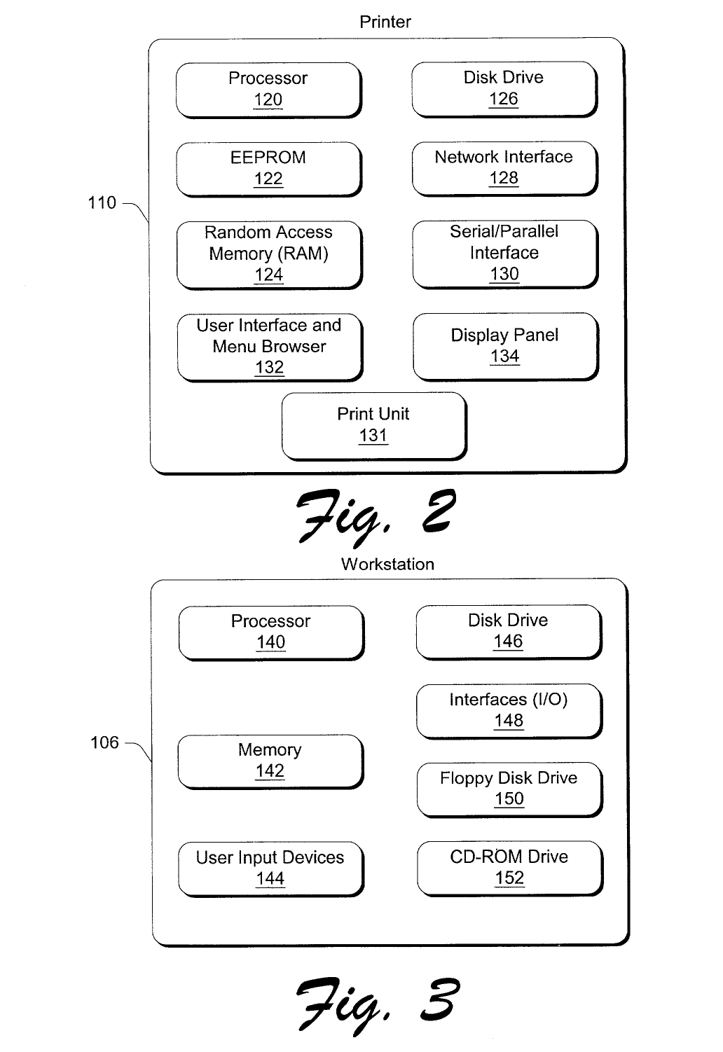

FIG. 2 is a block diagram showing exemplary components of printer 110 in accordance with one embodiment. Printer 110 includes a processor 120, an electrically erasable programmable read-only memory (EEPROM) 122, and a random access memory (RAM) 124. Processor 120 processes various instructions necessary to operate the printer 110 and communicate with other devices. EEPROM 122 and RAM 124 store various information such as configuration information, fonts, templates, data being printed, and menu structure information. Although not shown in FIG. 2, a particular printer may also contain a ROM (non-erasable) in place of or in addition to EEPROM 122. Furthermore, a printer may alternatively contain a flash memory device in place of or in addition to EEPROM 122.

Printer 110 also includes a disk drive 126, a network interface 128, and a serial/parallel interface 130. Disk drive 126 provides additional storage for data being printed or other information used by the printer 110. Although both RAM 124 and disk drive 126 are illustrated in FIG. 2, a particular printer may contain either RAM 124 or disk drive 118, depending on the storage needs of the printer. For example, an inexpensive printer may contain a small amount of RAM 124 and no disk drive 118, thereby reducing the manufacturing cost of the printer. Network interface 128 provides a connection between printer 110 and a data communication network, such as network 100. Network interface 128 allows devices coupled to a common data communication network to send print jobs, menu data, and other information to printer 110 via the network. Similarly, serial/parallel interface 130 provides a data communication path directly between printer 110 and another device, such as a workstation, server, or other computing device. Although the printer 110 shown in FIG. 2 has two interfaces (network interface 128 and serial/parallel interface 130), a particular printer may only contain one interface.

Printer 110 also includes a print unit 131 that includes mechanisms that are arranged to selectively apply ink (e.g., liquid ink, toner, etc.) to a print media (e.g., paper, plastic, fabric, etc.) in accordance with print data within a print job. Thus, for example, print unit 131 can include a conventional laser printing mechanism that selectively causes toner to be applied to an intermediate surface of a drum or belt. The intermediate surface can then be brought within close proximity of a print media in a manner that causes the toner to be transferred to the print media in a controlled fashion. The toner on the print media can then be more permanently fixed to the print media, for example, by selectively applying thermal energy to the toner. Print unit 131 can also be configured to support duplex printing, for example, by selectively flipping or turning the print media as required to print on both sides. Those skilled in the art will recognize that there are many different types of print units available, and that for the purposes of the present invention print unit 131 can include any of these various types.

Printer 110 also contains a user interface/menu browser 132 and a display panel 134. User interface/menu browser 132 allows the user of the printer to navigate the printer's menu structure. User interface 132 may be a series of buttons, switches or other indicators that are manipulated by the user of the printer. Display panel 134 is a graphical display that provides information regarding the status of the printer and the current options available through the menu structure.

The illustrated printer can, and typically does include software that provides a runtime environment in which software applications or applets can run or execute. One exemplary runtime environment is a Java Virtual Machine (JVM). Other runtime environments can, of course, be used. The runtime environment can facilitate the extensibility of the printer by allowing various interfaces to be defined that, in turn, allow applications or applets to interact with the printer in more robust manners.

Exemplary WorkStation Architecture

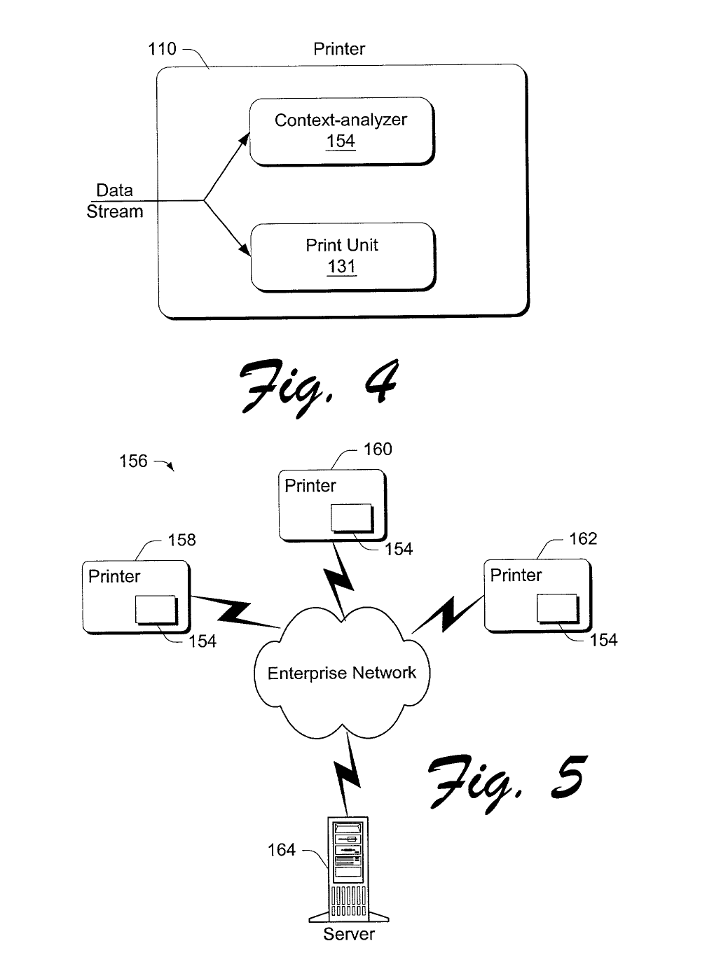

FIG. 3 is a block diagram showing exemplary components of a computer workstation 106. Workstation 106 includes a processor 140, a memory 142 (such as ROM and RAM), user input devices 144, a disk drive 146, interfaces 148 for inputting and outputting data, a floppy disk drive 150, and a CD-ROM drive 152. Processor 140 performs various instructions to control the operation of workstation 106. Memory 142, disk drive 146, and floppy disk drive 150, and CD-ROM drive 152 provide data storage mechanisms. User input devices 144 include a keyboard, mouse, pointing device, or other mechanism for inputting information to workstation 106. Interfaces 148 provide a mechanism for workstation 106 to communicate with other devices.

Exemplary Context-Analyzer

FIG. 4 shows printer 110 with only a couple of components for purposes of the explanation that follows. These components include print engine 131 and a context-analyzer 154. The context-analyzer is preferably implemented in software and resides within the printer. In embodiments where the printer includes a runtime environment, such as Java Virtual Machine, the context-analyzer resides in or is supported by the runtime environment. It should be appreciated and understood that while the context analyzer is shown as being located entirely within the confines of printer 110, various aspects of its functionality can be distributed across different computing devices.

As a data stream is received by printer 110 for printing, the data stream is typically processed for printing. Eventually, the data stream is provided to print engine 131 for printing onto a media as described above. In accordance with one described embodiment, context-analyzer 154 also receives the data stream and is configured to analyze the data stream. The analysis that is performed on the data stream by the context-analyzer pertains to, as the name implies, the context of the data stream itself. That is, each data stream that is printed by the printer necessarily has some context associated with it. For example, the data stream might represent an employment report, financial report, personnel evaluation, resume, or some other specific type of document. The context-analyzer is programmed to receive the data stream, analyze the data stream, and then provide some type of information regarding the type of document that has been printed.

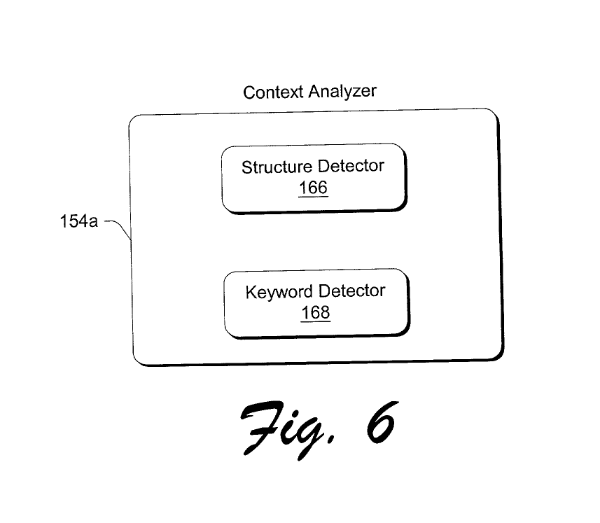

As an example, consider FIG. 5 which shows an enterprise network 156 that includes three exemplary printers 158, 160, 162. Each printer is configured with a context-analyzer 154. A server computer 164 is provided and is communicatively linked with the printers via the network. Assume that in this organization, the organization is very interested in performing statistical analysis regarding the usage characteristics of each of its printer resources. That is, the organization desires to determine what types of documents are printed on the organization's various printer resources, and the numbers of such documents. In this example, context-analyzer 154 on each printer can be programmed to ascertain the context of each document that is printed on a printer by looking specifically at the data stream that defines the document. By analyzing the data stream, each context-analyzer can accumulate information pertaining to the data stream that can then be used to ascertain the type of documents that are being printed by the printer. This accumulated information can be processed by the individual context-analyzers to make determinations concerning their own documents, or the accumulated information can be provided to another entity, e.g. server computer 164, for such determinations.

Consider further the case where an organization is concerned with tracking or monitoring security issues. For example, in a particular organization, printer 158 may be a secure printer that is designated for printing sensitive material, while printers 160 and 162 are located in areas where they are not secure and so cannot be used for sensitive material. By having each printer configured with a context-analyzer, each data stream that is printed on a particular printer can be analyzed to accumulate information concerning whether the corresponding document is or is not a sensitive document.

With such information having been accumulated (i.e. information concerning the context of documents printed on the printers), the organization is now in a position to accurately analyze the results and make conclusions as to the nature or types of documents that are being printed on individual printers, or on the organization's printers as a whole. In the example above where the context-analyzers are used to ascertain whether sensitive documents are being printed on unsecure printers, if such is found to be the case, the organization might put in place some remedial measures to ensure that this does not occur in the future.

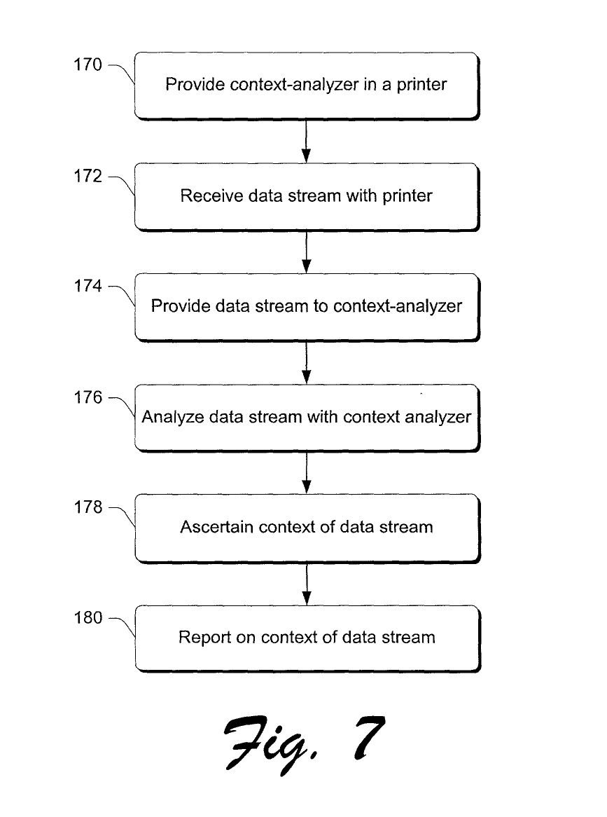

FIG. 6 shows an exemplary context-analyzer 154a in accordance with one embodiment. In this example, the context-analyzer includes a structure detector component 166 and a keyword detector component 168. These components assist the context-analyzer in ascertaining the context of documents associated with data streams that it processes.

The structure detector component 166 can be programmed to analyze a data stream so that it can ascertain the structure of the document that is to be printed. For example, forms that are used throughout an organization are typically standardized in their format or structure. There may be predefined fields within the document that, as with some forms, are always going to be present. Thus, if the specific structure of a document is known ahead of time, the structure detector component can be programmed to look for the specific structure in a data stream. Each time such a structure is found, the context-analyzer 154a can conclude that the data stream is associated with a form of interest.

The keyword detector component 168 works along related but different lines. Consider that certain types of documents typically contain keywords or phrases that are generally known to occur within those types of documents. For example, an employee evaluation form might always include the phrase “Employee Evaluation Form 10A”. Hence, by knowing the types of keywords or phrases that typically occur within certain types of documents, keyword detector component 168 can be programmed to specifically look for those types of keywords or phrases. From this, the context-analyzer can ascertain the type of document that is represented by the data stream.

Thus, in this example, various types documents are able to be described by their profiles. The context-analyzer is able to be programmed to look for specific document profiles in the data streams that represent the documents. By identifying documents that meet certain definable profile characteristics, the context-analyzer can make intelligent decisions as to the nature or type of documents that are being printed.

Exemplary Method

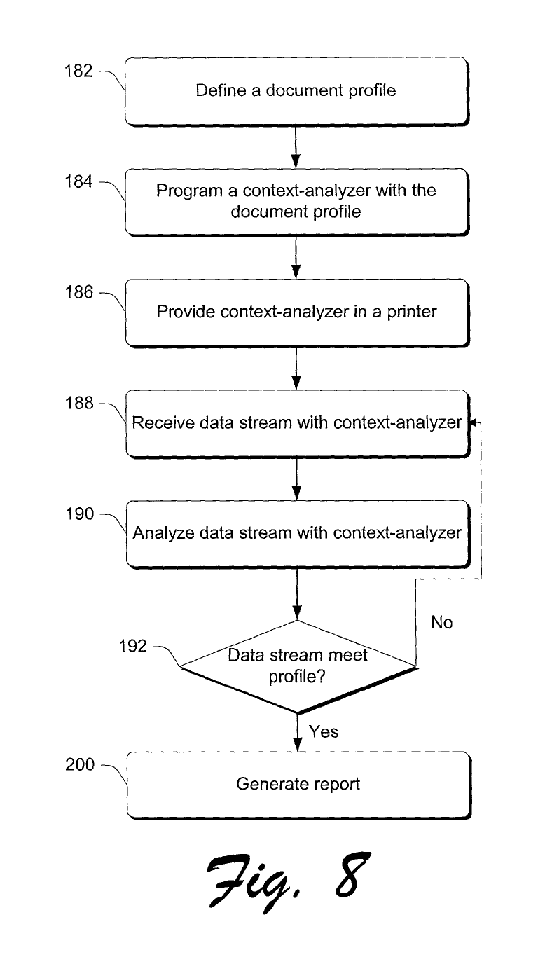

FIG. 7 is a flow diagram that describes steps in a method in accordance with one embodiment. The steps can be implemented in any suitable hardware, software, firmware, or combination thereof. In the illustrated example, most if not all of the steps can be implemented in software.

Step 170 provides a context-analyzer in a printer. The context-analyzer can be provided in the printer in any suitable way. For example, a printer can be originally configured with a context-analyzer when it is built. Alternately, the printer can provided with a context-analyzer at some later date. Any method or mode of delivery can be used to provide the context-analyzer to the printer. For example, the context-analyzer can be loaded onto the printer via a computer-readable medium such as a CD or hard disk. In one particular embodiment, the context-analyzer is delivered to the printer over a network, such as the Internet, in the form of an application or applet that can run on the printer. In addition, in various embodiments the context-analyzer can be self-replicating and self-directing. Specifically, if a context-analyzer is resident on one printer within a network, it can be programmed to seek out other network printer resources, copy itself, and then provide the copy to the other network resources. Accordingly, the context-analyzer can be provided to one or more printers in any number of suitable ways.

Step 172 receives a data stream into the printer on which a context-analyzer resides. The data stream represents a document that is to be printed by the printer. The data stream can be in any suitable form, format or state. Step 174 provides the data stream to the context-analyzer and step 176 analyzes the data stream with the context analyzer. Specific examples of how this can be done are given above and described in connection with FIG. 6. It is to be appreciated and understood that any suitable method can be used for analyzing a data stream for its context. The examples given above, i.e. structure and keyword analysis, constitute but two exemplary ways of analyzing a data stream for its context. Other ways can, of course, be utilized.

Step 178 ascertains one or more contexts associated with the data stream. This step is implemented by evaluating the information that is produced by step 176 and making a decision based upon that information. It should be appreciated and understood that this step-that of evaluating the information produced from an analysis of the data stream-need not be performed by the context-analyzer itself. Rather, the context-analyzer can accumulate information through its analysis of the data stream and then provide the accumulated information to another entity, as noted above, so that the context of the data stream can be ascertained.

Step 180 reports on the context of the data stream. Exemplary ways of implementing this step include, without limitation, the following ways. First, if the context-analyzer is programmed to perform steps 176 and 178, then this step can be implemented by the context-analyzer itself. This can involve reporting the context information to another computing entity (such as a corporate server) via a corporate network. Second, if the context-analyzer is not programmed to perform step 178 (that of ascertaining the context of the data), then this step can be implemented by the entity that did in fact perform this step.

Data Monitoring

In many instances, organizations or, more accurately, information managers or those associated with security functions within an organization are interested in monitoring and overseeing security issues within the organization. One of the security issues, as alluded to in the “Background” section pertains to what is printed on an organization's printers. For example, certain sensitive material may be so sensitive that it is only to be printed on a specific designated secure printer and by a few specially designated people. This material might, for example, concern an organization's corporate strategy or future, yet-to-be-released products. In these instances it becomes especially critical for the organization to police the content of its printers.

Within this context, the context-analyzers of an organization can be configured to monitor for secure information or, for that matter, any information of a specific nature. Upon detecting data streams that correspond to the monitored information, the context-analyzer can generate a notification or send the data stream to an appropriate authority within the organization for further analysis.

Consider again FIG. 5 and the enterprise network 156. Assume in this example that the organization is interested in looking for certain profile material that is being printed on its printers. The profile of such material might be that which is associated with sensitive material, personal material that is being printed on organization resources, or any other material for which an organization may be inclined to monitor. Each of context-analyzers 154 can be configured to look specifically for data streams associated with documents that meet one or more profiles defined by the organization. Accordingly, the context-analyzers are looking at the specific content of the data streams to ascertain whether their associated documents fall within a profile of interest. If a particular data stream is determined to be associated with a profile of interest, a notification or the data stream itself can be sent to another computer for further analysis.

FIG. 8 is a flow diagram that describes steps in a method in accordance with one embodiment. The steps can be implemented in any suitable hardware, software, firmware, or combination thereof. In the illustrated example, most if not all of the steps can be implemented in software.

Step 182 defines a document profile. Any suitable document profile can be defined. In addition, any suitable way of defining a particular document profile can be used. In this example, the document profile pertains to a specific document or type of document in which the organization is interested. The profile can be defined in terms of keyworks, clusters of keywords, frequency of occurrence of keywords or phrases, Boolean combinations of keywords or phrases and the like. There are simply numerous known ways to define document profiles that will be appreciated and understood by those of skill in the art. Some exemplary ways are disclosed in the following U.S. Patents, the disclosures of which are incorporated by reference herein: 6,119,114, 6,109,023, 5,995,638, 5,778,363, 5,774,888, and 5,724,567.

Step 184 programs a context-analyzer with the document profile and step 186 provides the context-analyzer in a printer. These steps need not be performed in this order. That is, a context-analyzer can be configured after it is provided in the printer. Step 186 is similar to step 170 in FIG. 7. That is, the context-analyzer can be provided in the printer in any suitable way. Step 188 receives a data stream with the context-analyzer. The data stream that is received by the context-analyzer can constitute any data stream within the printer. Specifically, the data stream can comprise the stream as actually received by the printer, or it can comprise some modified form of the data stream within the printer. Step 190 analyzes the data stream with the context analyzer. This step is implemented by comparing the data stream with the defined document profile. Step 192 determines whether the data stream meets the profile within some degree of certainty. If the data stream appears to meet the profile, then step 200 generates a report pertaining to the data stream. This report can be a simple notification, or it can comprise the data stream itself. The generated report can then be sent onto whatever authority/entity is interested in the report. If, on the other hand, step 192 determines that the data stream does not meet the profile, then the method branches back to step 188 to receive more data streams.

Conclusion

The above-described methods and systems provide a means by which an organization can monitor the content of documents being printed on organization printer resources. The techniques described herein are advantageous from the standpoint of being transparent from the point of view of the user. This can add a degree of stealthyness that in some scenarios can increase the likelihood of the organization uncovering situations that present security risks. The techniques and systems are also advantageous from the standpoint of providing tools for an organization to use to more efficiently manage and oversee its printer resources.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

I claim:

1. A method of operating a printer comprising:
monitoring content of one or more documents that are to be printed on a printer, said monitoring taking place within a printer that is to print the one or more documents;
determining whether the monitored content is of interest to an organization of which the printer comprises a part; and
generating a notification if the content is of interest to the organization.

2. The method of claim 1, wherein said monitoring comprises receiving and analyzing a data stream in the printer, the data stream pertaining to the one or more documents that are to be printed.

3. The method of claim 1, wherein said determining comprises ascertaining whether the content includes one or more keywords or phrases;

4. The method of claim 1, wherein said determining comprises ascertaining whether the content comprises a particular structure.

5. The method of claim 1, wherein said generating comprises generating a notification that includes at least a portion of the content that is of interest to the organization.

6. A method of operating a printer comprising:
providing a context-analyzer within a printer;
receiving a data stream into the printer, the data stream representing a document that is to be printed by the printer;
providing a data stream to the context-analyzer; and
analyzing the provided data stream with the context-analyzer to ascertain one or more contexts associated with the data stream.

7. The method of claim 6, wherein said providing of the context-analyzer comprises delivering the context-analyzer to the printer via a network.

8. The method of claim 6, wherein said providing of the context-analyzer comprises delivering the context-analyzer in the form of an applet to the printer via a network.

9. The method of claim 6, wherein said analyzing comprises using a structure detector that is configured to analyze the data stream so that it can ascertain a structure associated with a document that is to be printed.

10. The method of claim 6, wherein said analyzing comprises using a keyword detector that is configured to analyze the data stream so that it can ascertain one or more keywords or phrases that appear in a document that is to be printed.

11. The method of claim 6 further comprising self-replicating the context-analyzer to other printers on a network.

12. The method of claim 1, said self-replicating comprises:
seeking out other network printers;
copying the context-analyzer; and
providing at least one copy of the context-analyzer to the other network printers.

13. The method of claim 6 further comprising reporting on the context of the data stream.

14. The method of claim 13, wherein said reporting comprises reporting context information to a computing entity.

15. A method of operating a printer comprising:
defining a document profile;
programming a context-analyzer with the document profile;
providing the context-analyzer within a printer;
receiving a data stream with the context-analyzer, the data stream being associated with a document that is to be printed by the printer;
analyzing the data stream with the context-analyzer; and
determining whether the data stream meets the document profile within some degree of certainty.

16. The method of claim 15, further comprising generating a notification if the document profile is met.

17. The method of claim 15, wherein said programming occurs after said providing.

18. The method of claim 15, wherein said defining of the document profile comprises doing so using one or more keywords or phrases.

19. One or more computer-readable media having computer-readable instructions thereon which, when executed by a printer, cause the printer to:
monitor content of one or more documents that are to be printed on a printer;
determine whether the monitored content is of interest to an organization; and
generate a notification if the content is of interest to the organization.

20. The computer-readable media of claim 19, wherein the instructions cause the printer to determine whether the content is of interest by comparing document content with one or more defined profiles that describe information that is of interest to the organization.

21. An apparatus comprising:
at least one printer; and
a context-analyzer resident in said at least one printer and configured to monitor content of one or more documents that are to be printed on the printer and determine whether the content is of interest to an organization of which the printer comprises a part.

22. The apparatus of claim 21, wherein the context-analyzer is configured to generate a notification if the content is of interest to the organization.

23. The apparatus of claim 21, wherein the context-analyzer is configured to self-replicate itself to other printers across a network to which the at least one printer has access.

24. The apparatus of claim 21 further comprising:
at least one other printer having a context-analyzer; and
a network configured to establish a communication link between the printers.

25. An apparatus comprising:
at least one printer; and
a context-analyzer resident in the printer and configured to:
receive a data stream within the printer, the data stream representing a document that is to be printed by the printer; and
analyze the data stream to ascertain one or more contexts associated with the data stream.

26. The apparatus of claim 25, wherein the context-analyzer is configured to analyze the data stream by using a structure detector to detect a structure of a document that is to be printed.

27. The apparatus of claim 25, wherein the context-analyzer is configured to analyze the data stream by using a keyword detector that is configured to analyze a data stream so that it can ascertain one or more keywords or phrases that appear in a document that is to be printed.

28. The apparatus of claim 25 further comprising:
at least one other printer having a context-analyzer; and
a network configured to establish a communication link between the printers.

29. The apparatus of claim 28, wherein said context-analyzer is configured to self-replicate itself to other printers on the network.

30. An architecture comprising:
one or more context-analyzers, each of which being configured to:
receive a data stream within a printer, the data stream representing a document that is to be printed by the printer; and
analyze the data stream to ascertain one or more contexts associated with the data stream.

31. The architecture of claim 30, wherein the context-analyzers are configured to generate a notification based on the context of a data stream.

32. The architecture of claim 30, wherein the context-analyzers are configured to analyze the data stream by comparing content of the data stream with one or more profiles defining information of interest.
